(19) United States
(12) Patent Application Publication
(10) Pub. No.: US 2013/0083069 A1
(43) Pub. Date: Apr. 4, 2013

(54) METHOD AND APPARATUS FOR INTERACTIVELY DISPLAYING ELECTRONIC FILE IMAGES

(71) Applicant: Samsung Electronics Co., Ltd., Suwon-si (KR)

(72) Inventors: Yevgen YAKISHYN, Kyiv (UA); Andrey Fisunenko, Kherson (UA); Oleksandr Voloshko, Kyiv (UA); Evgen Saliuk, Kyiv (UA)

(73) Assignee: Samsung Electronics Co., Ltd., Suwon-si (KR)

(21) Appl. No.: 13/628,782

(22) Filed: Sep. 27, 2012

(30) Foreign Application Priority Data
Sep. 30, 2011 (KR) 10-2011-0099657

(51) Int. Cl. G06F 3/041; G09G 5/00

(52) U.S. Cl. 345/634; 345/173

(57) ABSTRACT

A method and apparatus are provided for displaying electronic files. Electronic file images are displayed in at least one divided exhibition region. It is determined whether a plurality of electronic file images is selected from the electronic file images based on a selection input. A display change input is received for changing a display of the plurality of electronic file images when the plurality of electronic file images is selected from the electronic file images. A display of the plurality of electronic file images is changed according to the display change input.

### PRIORITY

This application claims priority under 35 U.S.C. §119(a) to Korean Patent Application No. 10-2011-0099657, which was filed in the Korean Intellectual Property Office on Sep. 30, 2011, the entire disclosure of which is incorporated herein by reference.

### BACKGROUND OF THE INVENTION

1. Field of the Invention

The present invention relates generally to a method and an apparatus for displaying electronic files in a terminal with a touch screen, and more particularly, to a method of interactively displaying electronic files according to user input through a touch screen, and an apparatus thereof.

2. Description of the Related Art

Touch screens provide a more convenient and intuitive input scheme than key input units of a touch input scheme. Thus, utilization of touch screens has increased. A touch screen includes a touch panel and a display unit, and is provided as an essential function unit of various types of electronic devices.

Applications executed according to input through a touch screen have been generalized. These applications provide a Graphic User Interface (GUI), which utilize advantages of the touch screen.

In particular, in the GUI of a file management application, electronic files are displayed as an image that is similar to an actual object, and a scheme providing a file list is displayed to imitate a real-life receiving scheme.

However, a GUI display method is typically fixed. Accordingly, although an image that is similar to real life is used, a GUI that is different from real life may be provided. Further, user-intervention for exhibiting various information in a desired scheme is very restrictive.

### SUMMARY OF THE INVENTION

The present invention has been made to address at least the above problems and/or disadvantages and to provide at least the advantages described below. Accordingly, an aspect of the present invention provides a method of interactively displaying electronic files, such that the display of images of the electronic files may be operated.

Another aspect of the present invention allows a user to freely use a limited exhibition region of electronic file images to display the file images.

A further aspect of the present invention further provides a method of allowing a user to optionally display electronic files by groups such that relationship of the electronic files may be easily recognized.

In accordance with an aspect of the present invention, a method is provided for displaying electronic files. Electronic file images are displayed in at least one divided exhibition region. It is determined whether a plurality of electronic file images is selected from the electronic file images based on a selection input. A display change input is received for changing a display of the plurality of electronic file images when the plurality of electronic file images is selected from the electronic file images. A display of the plurality of electronic file images is changed according to the display change input.

In accordance with another aspect of the present invention, an apparatus is provided for displaying electronic files. The apparatus includes a touch screen including a display unit for outputting electronic file images in at least one divided exhibition region, and a touch panel for receiving user input with respect to the electronic file images. The apparatus also includes a controller receiving a selection input of a plurality of electronic file image and a display change input from the touch screen, and controlling the touch screen to change a display of the plurality of electronic file images selected according to the display change input when it is determined that the plurality of electronic file images are selected according to the selection input.

### BRIEF DESCRIPTION OF THE DRAWINGS

The above and other aspects, features and advantages of the present invention will be more apparent from the following detailed description when taken in conjunction with the accompanying drawings, in which:

FIG. 1A is a block diagram illustrating a configuration of an apparatus for interactively displaying, according to an embodiment of the present invention;

FIG. 1B is a block diagram illustrating a configuration of a controller of FIG. 1A, according to an embodiment of the present invention;

FIG. 2 is a diagram illustrating an electronic file management screen, according to an embodiment of the present invention;

FIG. 3 is a flowchart illustrating a method of interactively displaying electronic files, according to an embodiment of the present invention;

FIG. 4 is a diagram illustrating a screen on which a plurality of electronic book images is displayed as one group, according to an embodiment of the present invention;

FIG. 5 is a diagram illustrating a screen on which a plurality of electronic book images is displayed by groups, according to another embodiment of the present invention;

FIG. 6 is a diagram illustrating an example of a screen changing locations of electronic book images, according to an embodiment of the present invention;

FIG. 7 is a diagram illustrating an example of a screen changing locations of electronic book images, according to another embodiment of the present invention;

FIG. 8 is a diagram illustrating a screen for providing a preview of a plurality of electronic book images, according to an embodiment of the present invention;

FIG. 9 is a diagram illustrating a screen for providing a preview image and a reading view image for one electronic file, according to an embodiment of the present invention;

FIG. 10 is a diagram illustrating a screen for actively displaying electronic book images, according to an embodiment of the present invention; and

FIG. 11 is a diagram illustrating a screen for actively displaying CD case images, according to an embodiment of the present invention.

### DETAILED DESCRIPTION OF EMBODIMENTS OF THE PRESENT INVENTION

Embodiments of the present invention are described in detail with reference to the accompanying drawings. The same or similar reference numbers may be used throughout the drawings to refer to the same or similar components. Detailed descriptions of constructions or processes known in the art may be omitted to avoid obscuring the subject matter of the present invention.

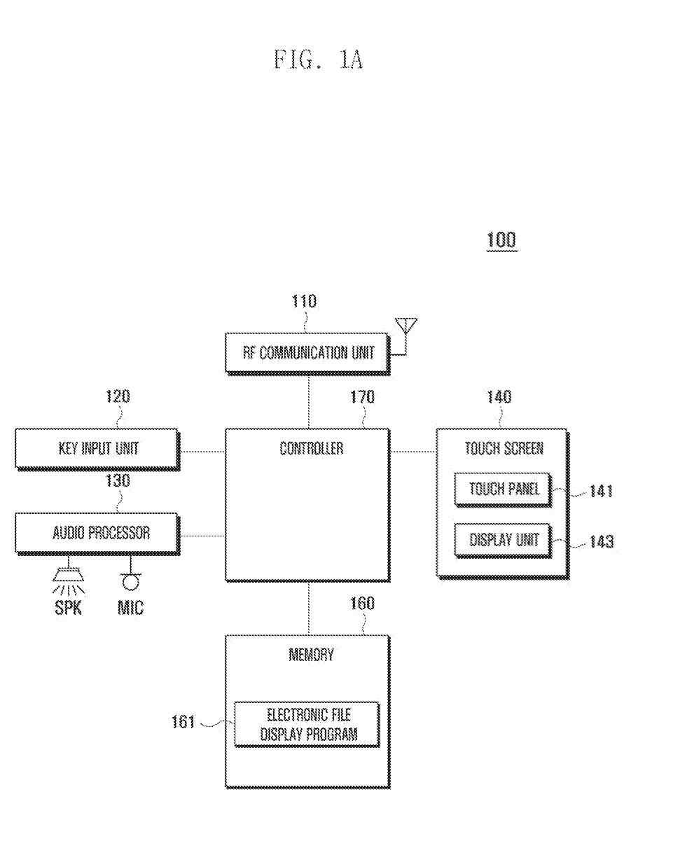

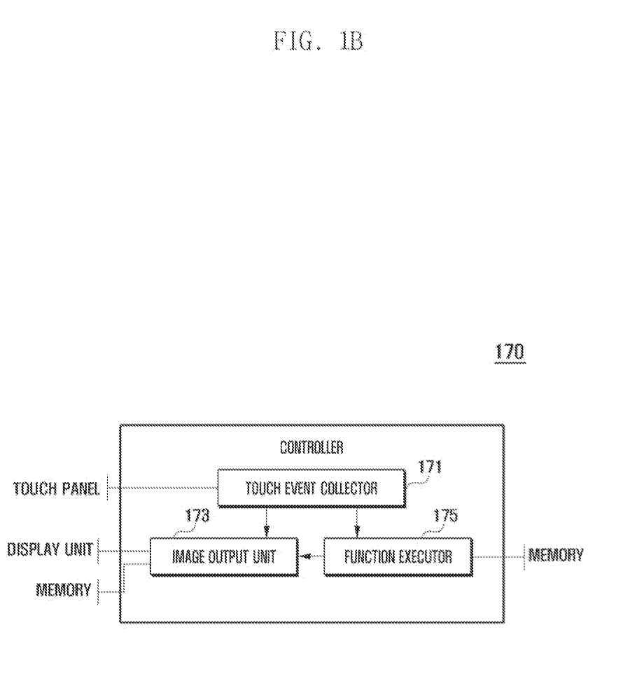

FIG. 1A is a block diagram illustrating a configuration of an apparatus (referred to ‘electronic file display’ hereinafter) 100 for interactively displaying, according to an embodiment of the present invention.

It is assumed herein that the electronic file display 100 is a mobile communication terminal such as, for example, a portable phone, a smart phone, or a tablet Personal Computer (PC), or is an electronic device, such as, for example, a television.

Referring to FIG. 1A, an apparatus for display of electronic files, according to an embodiment of the present invention, includes a Radio Frequency (RF) communication unit 110, a key input unit 120, an audio processor 130, a touch screen 140, a memory 160, and a controller 170.

The RF communication unit 110 forms a communication channel for a voice call, a communication channel for a video-phone call, and a communication channel (referred to as ‘data communication channel’ herein after) for transmitting images or messages under the control of the controller 170. In particular, the RF communication unit 110 of the invention receives electronic files through the data communication channel. Accordingly, the controller 170 stores the received electronic files in the memory 160, and controls the display unit 143 to display an electronic file management screen as an electronic file image.

The key input unit 120 includes a plurality of input keys and function keys for receiving input of numerals or character information, and for setting various functions. The function keys may include arrow keys, side keys, and short keys, which are set such that a certain function is performed. Further, the key input unit 120 generates and transfers key signals, which are associated with user settings and function controls of the apparatus for displaying electronic files, to the controller 170. When the touch screen 140 of the apparatus for displaying electronic files is supported in the form of a full touch screen, the key input unit 120 may include only a side key provided at a side of a case in the apparatus for displaying electronic files.

Particularly, the key input unit 120 of the invention generates and transfers a setting signal, which sets various display control schemes of an interactive display method, to the controller 170. Accordingly, the controller 170 supports an interactive display method of the present invention with reference to the received setting signal. Further, the key input unit 120 generates and transfers various selection input signals and display change input signals, with respect to electronic file images, to the controller 170. Moreover, the controller 170 changes a display scheme of the electronic file images, according to a received input signal. The key input unit 120 may be substituted by the touch screen, according to the form of the apparatus 100 for displaying electronic files, and may include simple side keys, hot keys, or home keys. According to this embodiment of the present invention, the input signals with respect to the foregoing selection input signal and selection change signal are generated by the touch screen 140. Hereinafter, the interactive display procedure is implemented through the touch screen 140.

The audio processor 130 includes a speaker SPK for playing audio data transmitted/received during a call, audio data included in a received message, and audio data according to playback of audio files stored in the memory 160. The audio processor 130 also includes a microphone MIC for collecting a user's voice or other audio signals during the call. Particularly, when the selection input signal or the display change signal is sensed, the audio processor 130 outputs a corresponding sound. The sound effect may be omitted according to user settings.

The touch screen 140 includes a touch panel 141 and a display unit 143. The touch screen 140 has a structure in which the touch panel 141 is arranged in a front surface of the display unit 143. The size of the touch screen 140 is determined by the size of the touch panel 141.

The touch panel 141 is disposed in at least one of upper and lower parts of the display unit 143, and sensors constituting the touch panel 141 are arranged in a matrix pattern. Accordingly, the touch panel 141 generates a touch event based on contact with or an approach distance of a touch object on the touch panel 141. The touch panel 141 transfers the generated touch event to the controller 170. Particularly, the touch panel 141 of the present invention generates a touch event for an interactive display scheme of an electronic file image. Specifically, the touch panel 141 generates a selection touch event and a display change touch event.

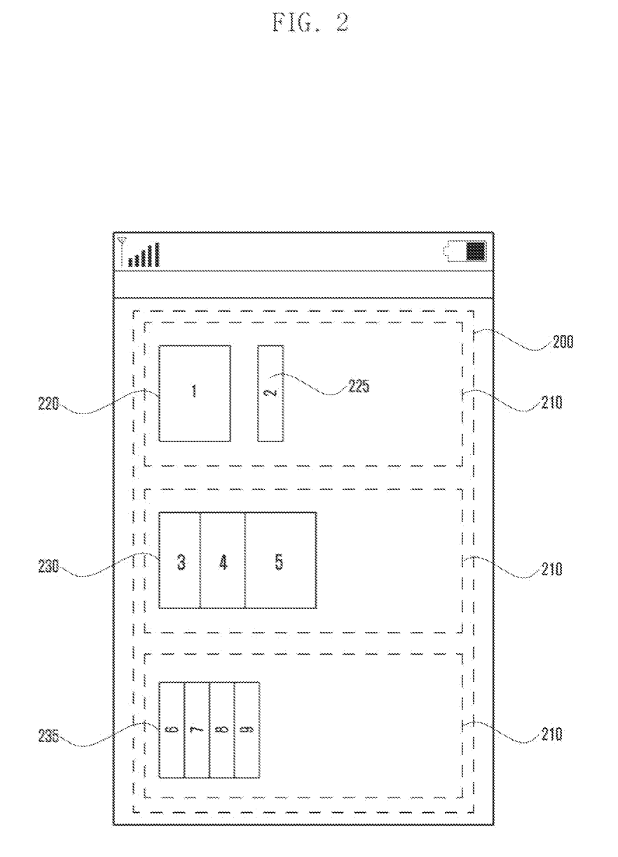

The display unit 143 displays information input by the user or information provided to the user, as well as various menus of an apparatus for displaying electronic files. Specifically, the display unit 143 provides various screens, according to the use of the apparatus 100, for displaying electronic files, for example, an electronic file management screen, a menu screen, or a home screen. The electronic file management screen is described in greater detail below with reference to FIG. 2. The display unit 143 may be configured as a Liquid Crystal Display (LCD), an Organic Light Emitted Diode (OLED), or the like. Further, the display unit 143 may be disposed in an upper part or a lower part of the touch panel 141. Particularly, the display unit 143 of the present invention interactively displays electronic file images according to a preset scheme under the control of the controller 170. A scheme for displaying electronic file images through the display unit 143 is described in greater detail below.

The memory 160 stores at least one application program necessary for a function operation, user data generated by the user, messages transmitted to and received from a network, data according to execution of an application program, and the like. The memory 160 primarily includes a program area and a data area.

The program area stores an Operating System (OS) for booting the apparatus 100, for displaying electronic files, and for operating the foregoing elements, and downloaded and installed applications. Particularly, the program area of the invention stores an electronic file display program 161.

The electronic file display program 161 includes routines supported for the interactive display of electronic file images. The electronic file display program 161 includes a selection determination routine and a display control routine.

The selection determination routine is set such that a selected electronic file is determined from electronic file images displayed on the electronic file management screen. The selection determination routine includes a selection input detection command and a count command determining the number of electronic file images selected according to selection input.

When a plurality of electronic file images are selected, the display control routine is programmed such that the display of electronic file images selected according to display change input is controlled. The display control routine includes a display change input detection command, a display change input type determination command, and a display control function execution command, according to a display change input type.

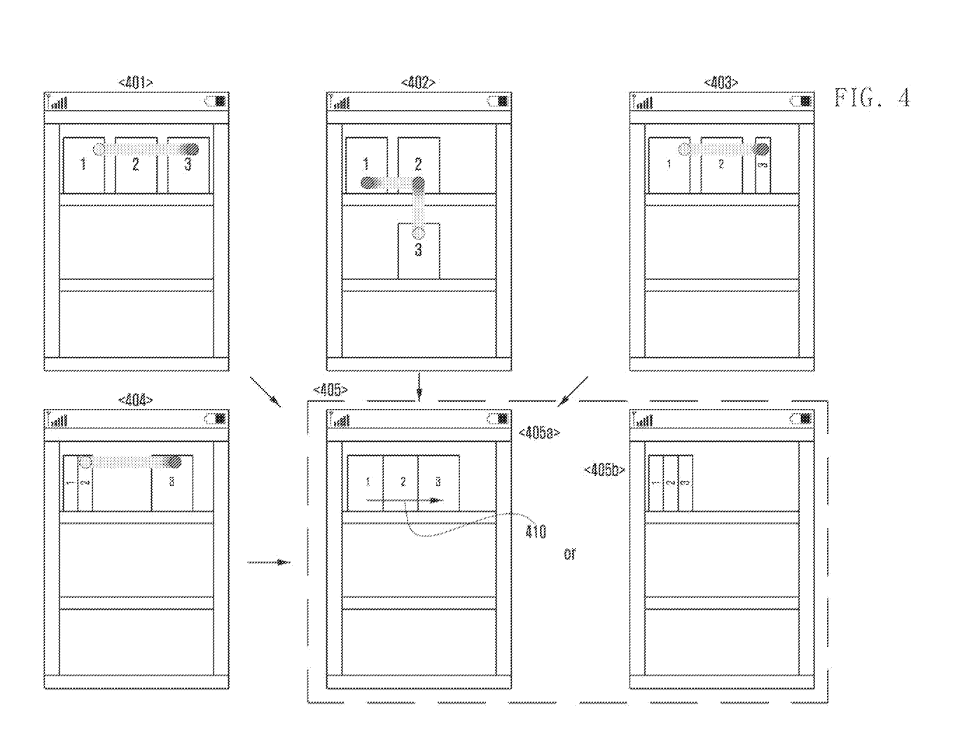

The data area of the memory 160 is an area in which data, which generated according to the use of the apparatus 100 for displaying electronic files, is stored. In particular, the data area of the present invention stores an electronic file management screen and electronic file images used or generated while the electronic file display program 161 is being executed. Various types of electronic file images may be stored for each electronic file. For example, a front view, a side view, a preview, and reading view images may be stored in the data area with respect to one electronic file. The various types of electronic file images are described in greater detail below with reference to FIGS. 4-10.

The controller 170 controls an overall operation of the apparatus for displaying electronic files. In particular, the controller 170 of the present invention controls an operation associated with an interactive display function operation of electronic file images, according to an embodiment of the present invention. For example, the controller 170 determines whether a plurality of electronic file images are selected, according to a received selection input, when an electronic file management screen is output. The controller also controls the display of the plurality of electronic file images according to display change input.

The controller 170 includes elements illustrated in FIG. 1B, according to an embodiment of the present invention.

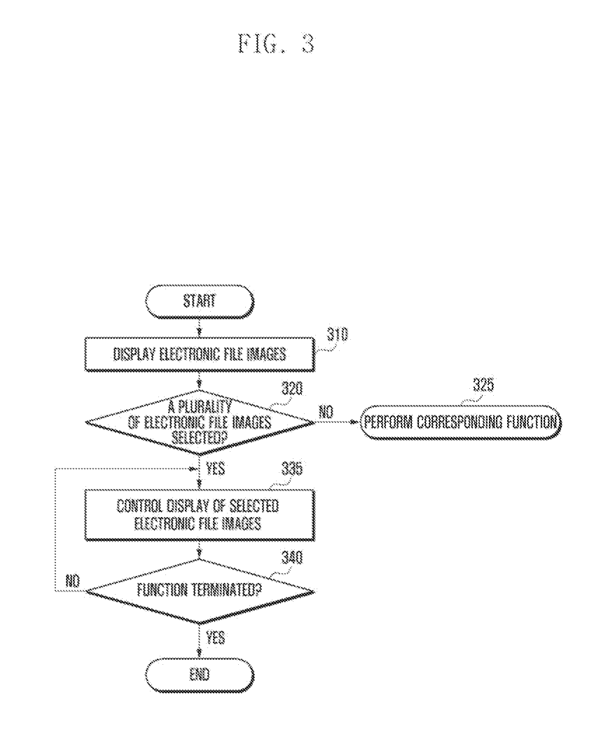

Referring to FIG. 1B, the controller 170 of the present invention includes a touch event collector 171, an image output unit 173, and a function executor 175. The touch event collector 171 receives input from the touch panel 141. Particularly, the touch event collector 171 collects selection input with electronic file images output from the display 143, and display change input with respect to selected electronic file images. The selection input and the display change input are described in greater detail with reference to FIG. 3.

The image output unit 173 controls the display unit 143 to output an electronic file management screen, including electronic file images, and controls the display unit 143 to change a display scheme of the electronic file images, according to a command of the function executor 175.

The function executor 175 executes various functions provided from the apparatus for displaying electronic files. In particular, the function executor 175 transfers an electronic file management screen display command causing output of electronic file images on the electronic file management screen to the image output unit 173. When the electronic file display program 161 is executed, the function executor 175 accesses the memory 160 and extracts an electronic file list and an electronic file image corresponding to each of electronic files included in the list from the memory 160. Further, the function executor 175 allows the extracted electronic file image to be displayed to a preset location in the electronic file management screen.

Moreover, when receiving a touch event from the touch event collector 171, the function executor 175 of the present invention accesses selection input and display change input setting information from the memory 160. In addition, the function executor 175 determines whether the received touch event is any one of preset selection input or display change input. Accordingly, if it is determined that a selection event or a display change event is received from the touch event collector 171, the function executor 175 transfers a display control command to the image output unit 173 to interactively display an electronic file image.

The foregoing embodiment of the present invention relates to the apparatus 100 for interactively display electronic file images. A method of interactively displaying the electronic file images is described in detail below.

FIG. 2 is a diagram illustrating an electronic file management screen 200, according to an embodiment of the present invention.

Referring to FIG. 2, the electronic file management screen 200 is divided into at least one region (referred to as an ‘exhibition region 210’ hereinafter), and at least one electronic file image is displayed on the exhibition region 210. Hereinafter, a bookshelf is displayed on the electronic file management screen 200, and the at least one exhibition region 210 is divided by a shelf as a main embodiment. The electronic file image indicates and identifies an electronic file. The electronic file image may be set as a certain image. Hereinafter, the present invention is described using a book image (referred to as an ‘electronic book image’ hereinafter) as an electronic file image of an electronic document file. The electronic file image may become various images, such as, for example, an electronic book image, a CD case indicating an audio file, a DVD case for a video file, and a thumbnail for an image file. Further, the electronic file image may be displayed in various views. The electronic file image may be displayed to be divided into an individual view and a binding view.

The individual view is used when one electronic file image is individually displayed. In an individual view, there is a front view 220 and a side view 225. Both of the front view 220 and the side view 225 have an image or a text for identifying electronic files. Because the front view 220 has a greater area than that of the side view 225, electronic file identification information with more electronic file images may be displayed in the front view 220. The electronic file image is advantageous in that a smaller area is displayed on the side view 225 for the display more electronic file images in a limited exhibition region. A more limited amount of identification information is displayed on the side view 225.

The binding view is used when a plurality of electronic book images, which are selected as a binding group, are displayed. The binding group is a display scheme for expressing a case in which a plurality of electronic book images is arranged. In the binding view, a plurality of electronic book images are displayed in adjacent locations in one common exhibition region. Accordingly, images of members of the binding group may be displayed as attached to each other or may be spaced apart from each other at an adjacent location. The images of members of the binded group may be arranged according to an order of binding input for group members, or may be listed in an alphabetical order of identification information, such as, for example, an electronic file name. An overlapping view 230 and a side-by-side view 235 are examples of the binding view. The visual effect of overlapping books is obtained in the overlapping view 230. The visual effect of books stored in a bookshelf is obtained in the side-by-side view 235. The overlapping view 230 and the side-by-side view 235 are described in greater detail below.

FIG. 3 is a flowchart illustrating a method of interactively displaying electronic files, according to an embodiment of the present invention.

Referring to FIG. 3, the controller 170 controls the display unit 143 to display electronic file images on an electronic file management screen, in step 310. The controller 170 supports the display of the electronic file management screen 200 as illustrated in FIG. 2. Accordingly, the controller 170 supports the display of electronic file images in an individual view or a binding view in at least one divided exhibition region.

The controller 170 determines whether a plurality of electronic file images, which are displayed on the electronic file management screen, are selected, in step 320. The controller 170 determines whether selection input with respect to a plurality of electronic file images is received. If a single selection input is received many times or one group selection input is received, the controller 170 determines that a plurality of electronic file images are selected. The single selection input is input selects one electronic file image, and the group selection input selects one binding group. When receiving the group selection input, the controller 170 determines that all members of a corresponding binding group are selected. Accordingly, a plurality of electronic file images constituting the corresponding binding group may be selected by the group selection input.

If it is determined that the plurality of electronic file images are selected, the controller 170 controls the display of the selected electronic file images, in step 335. Conversely, when the plurality of electronic file images is not selected, the controller 170 performs a corresponding function, in step 325. For example, if it is determined that one electronic file image is selected in step 320, the controller 170 controls the display unit 143 to convert an individual view of the electronic file image, to output a corresponding preview image or reading view, or to change a display location according to the received input.

The controller 170 controls the display of the plurality of electronic file images, which were selected according to received display change input, in step 335. The display change input is input for changing the display of at least one electronic file image. The display change input received at step 335 is displayed such that a plurality of selected electronic file images are converted into a type of view, or the locations thereof are converted. The foregoing selection input and display change input may be detected by a series of touch inputs, such as, for example, continuously received flicks, or by one independent touch input, such as, for example, a tap or drag.

In an embodiment of the present invention, received display change inputs include, for example, binding inputs, display region reduction commands, display region extension commands, location moving inputs, preview display inputs. If the binding input is received, the controller 170 controls the display unit 143 to display a plurality of selected electronic book images as one binding group. The controller 170 adjusts a display region of a binding group according to the display region reduction command and the display region extension command. If the display region reduction command is received, the controller 170 modifies a binding view such that a display region of the binding group is reduced. Conversely, if the display region extension command is received, the controller 170 enlarges a binding view display region. Accordingly, a display region of a plurality of electronic book images configuring the binding group may be adjusted. The controller 170 may control the display unit 143 to output a selection view displaying a binding group selected when group selection input is selected. Further, when the location moving input is received, the controller 170 supports changing a display location of the binding group to a certain location. Moreover, if the preview display input is received, the controller 170 supports displaying a preview image corresponding to a plurality of electronic book images configuring a selected binding group.

After the display control by predetermined display change input, the controller 170 determines whether a function is terminated, in step 340. If another display change input is not received, the controller terminates a display control function. When the other display change input is received, the controller 170 returns to step 335.

The display of electronic book images according to various types of display change inputs, is described in detail below with reference to FIGS. 4-6.

FIG. 4 is a diagram illustrating a screen on which a plurality of electronic book images are displayed as one group, according to an embodiment of the present invention.

Referring to FIG. 4, the controller 170 supports the selection of a plurality of electronic book images, which are output on screen 401 to screen 404, as one binding group, and the display of a binding group on screens 405a and 405b, through various schemes.

In order to express a plurality of electronic book images as one binding group, when the plurality of electronic book images displayed on the electronic file management screen are sequentially selected, the controller 170 determines that binding input is received for displaying the selected electronic book images as one binding group. Accordingly, the controller 170 controls the display unit 143 to display the selected electronic book images with a certain binding view. If a plurality of electronic book images are multi-touched on the touch panel 141, which is capable of supporting a multi-touch function, the controller 170 support displaying the multi-touched electronic book images with a type of a binding view. Further, when the multi-touch is cancelled, the controller 170 terminates a binding view display change function.

If a plurality of independent selection inputs are generated, as illustrated in screen 401, the controller 170 determines whether the binding input is received and determines that a plurality of electronic book images, for example, an electronic book image 1 to an electronic book image 3, are selected. The single selection input is generated in one electronic book image region, and is preset input to select the one electronic book image. For example, the single selection input may be set as a tap event or a drag event. As illustrated in screen 401, when a drag event is generated from a region of the electronic book image 3 to the region of electronic book image 1, the controller 170 determines that the electronic book image 1 to the electronic book image 3 are selected.

Although the selection of electronic book images displayed with the same type of individual view in one common exhibition region is illustrated in screen 401, a plurality of electronic book images may be selected in the exhibition region. For example, although electronic book images displayed in other exhibition regions are selected, as illustrated in screen 402, the controller 170 determines whether binding input is received. Accordingly, as illustrated in screen 402, electronic book images displayed on upper and middle exhibition regions may be selected as one binding group.

Further, the controller 170 may support selection of electronic book images having different types of individual views as one binding group. For example, as illustrated in screen 403, when a single selection input is generated in electronic book images with a front view or a side view, the controller 170 may determine that binding input is received.

Furthermore, when selection input is generated from one electronic book image and one binding group, the controller 170 may determine that the binding input is received. For example, referring to screen 404, when a single selection input is generated in a display region of the electronic book image 3 and group selection input is then generated in a binding view display region configured by the electronic book image 1 and the electronic book image 3, the controller 170 determines that the binding input is received. Accordingly, the controller 170 supports the addition of one electronic book image to a plurality of electronic book images displayed as a binding group. Accordingly, when one electronic book image is added as a regular publication or a serial story, the controller 170 may display the added image to be included in a corresponding binding group. The controller 170 may add an animation effect that allows a user to recognize the binding group to which an added electronic book image is included. The foregoing group selection input is preset and is generated in one binding view region for selecting one binding group. For example, the group selection input may be set as a tap event or a drag event. Accordingly, electronic book images with different individual views, binding views, and exhibition regions may be also selected as one binding group.

When it is determined that a plurality of electronic book images are selected as illustrated in screen 401 to screen 404, the controller 170 displays a plurality of selected electronic book images, as illustrated in screen 405b, according to a preset binding view. The type of binding views with which a plurality of selected electronic book images will be displayed can be set.

For example, if a binding group is set to be displayed as an overlapping view, the controller 170 supports the display of electronic book images as illustrated in screen 405a. In the overlapping view, a total front view is displayed on one image, and a part of the front view of a preset overlapping ratio is displayed on other images. Electronic book images are displayed to overlap in the overlapping view in one consistent overlapping direction 410. The overlapping direction 410 is a direction in which electronic book images overlap. For example, if the overlapping direction 410 is toward the right, the display unit 143 displays electronic book images, which sequentially overlap in an order from the left to the right. The foregoing overlapping order may correspond to a selection order of electronic book images. As finally arranged, the right most electronic book image is displayed such that a total front view is shown, and remaining electronic book images are displayed with only a part of the front view shown. Further, the electronic book image in which the total front view is displayed may be the first selected electronic book image. The controller 170 supports displaying the remaining electronic book images according to a preset overlapping ratio. In the overlapping view, a certain ratio of the remaining electronic book images is not shown according to the preset overlapping ratio. The preset overlapping ratio may be set according to a taste of a user, or may be automatically set according to a possible exhibition space of an exhibition region on which a binding group is displayed. For example, in order to display a plurality of electronic file images in a certain exhibition region, the controller 170 may set a high overlapping ratio through a series of calculation procedures. By contrast, when a small number of electronic file images are displayed in a certain exhibition region, the controller 170 may set a significantly lower overlapping ratio. As described above, a visual effect of overlapping books overlap may be obtained in the overlapping view.

The binding group may also be displayed with a side-by-side view. The controller 170 supports displaying a binding group with the side-by-side view, as illustrated in screen 405b. Side views of group members are displayed to be adjacent to each other in the side-by-side view. Members of the binding group may be spaced apart from each other by a predetermined distance. Accordingly, a visual effect of books stored in a bookshelf may be obtained in the side-by-side view.

As described above, the overlapping view or the side-by-side view has a smaller area when the same number of electronic book images are independently displayed.

Accordingly, an embodiment of the present invention illustrated in FIG. 4 displays a plurality of electronic book images in groups, which allows a user to make an empty space for reception and easily manage access by groups.

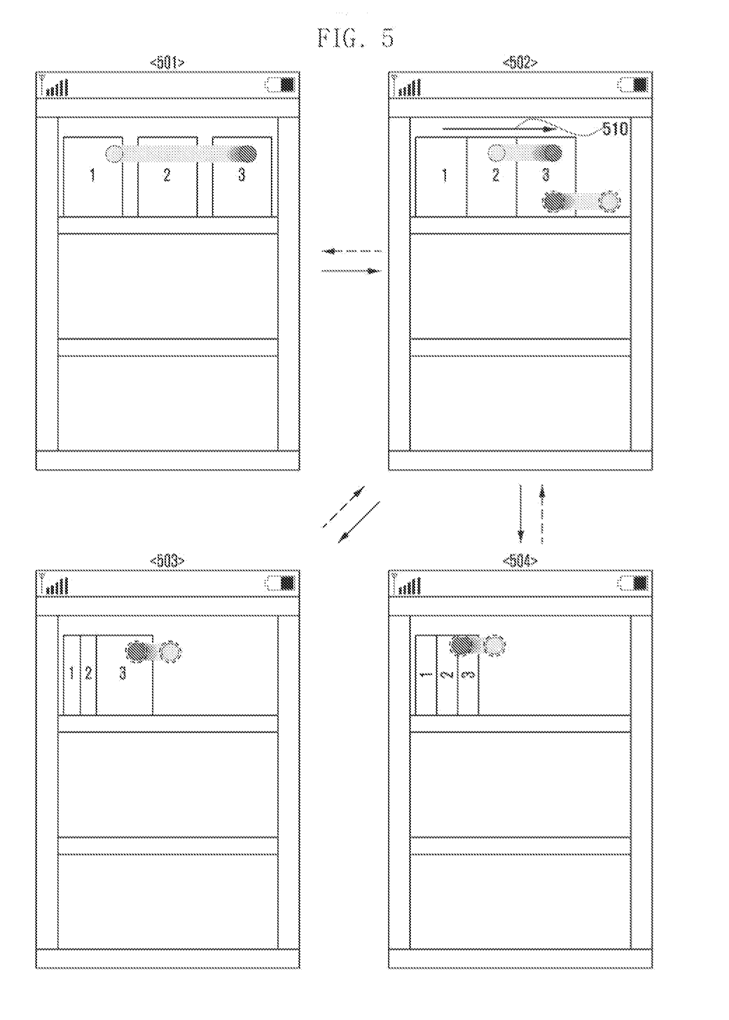

FIG. 5 is a diagram illustrating a screen on which a plurality of electronic book images are displayed by groups, according to another embodiment of the present invention.

Referring to FIG. 5, the controller 170 supports outputting binding views of a plurality of electronic book images that changed in stages. To change the binding views in stages, when one electronic book image is selected from binding group members, and input of a predetermined horizontal direction is received, the controller 170 determines that display change input changing a current binding view in a corresponding exhibition region is received. If a horizontal direction input is opposite the overlapping direction 510, the controller 170 determines that the input is a display region reduction command and modifies the display of a binding group such that a binding view display region is reduced in a corresponding exhibition region. However, if a horizontal direction input is received in the direction of an empty space in the exhibition region, the controller 170 determines that the input is a display region extension command and supports increasing a view display region in the corresponding exhibition region. The display modification input is set through input to a vertical direction.

If a plurality of electronic book images are selected as illustrated in screen 501, the controller 170 supports displaying selected electronic book images with an overlapping view, as illustrated in screen 502. If one of the electronic book images is selected from electronic book images, and input is received in a direction opposite to the overlapping direction 510, the controller 170 determines that the received input is a display region reduction command and supports reducing a binding view display region. As illustrated in screen 502, the controller 170 controls the display unit 143 to display an overlapping view in which the electronic book image 1 to the electronic book image 3 sequentially overlap from the left to the right. When an overlapping ratio is set to a preset primary ratio, for example, 20%, the controller 170 supports such that 20% of a right image of the electronic book image 1 and the electronic book image 2 is removed and a front view of a residual 80% is displayed. A total front view of the electronic book image 3 is displayed.

If the electronic book image 3 is selected from the electronic book images with an overlapping view in a screen 502 and input toward the left, which is opposite to the overlapping direction 510, is received, the controller 170 controls the display unit 143 to make the binding view display region shallower. Accordingly, the controller 170 supports displaying the electronic book image 1 to the electronic book image 3 as illustrated in screen 503 and screen 504. Specifically, the controller 170 adjusts an overlapping ratio to a preset secondary ratio, for example, 85%, and supports displaying the electronic book images according to the overlapping ratio. Accordingly, 85% of the right of the electronic book image 1 and the electronic book image 2 are removed, and only a residual 15% of a front view is displayed. However, the controller 170 supports displaying an overall front view of the electronic book image 3. More books may be overlapped for exhibition in the secondarily adjusted overlapping view, as illustrated in screen 503.

As illustrated in screen 504, the controller 170 changes a binding view of a plurality of electronic book images from an over view to a side-by-side view according to settings, when a display region reduction command is received. As previously described, when the binding view of a plurality of electronic book images is converted into the side-by-side view, electronic book images has a shallower display region than in screen 503.

Upon display control according to the display region reduction command, the controller 170 determines whether to use any one of the overlapping view using a secondary ratio of screen 503 or the side-by-side view of screen 504, according to the size of an electronic file. The controller 170 may determine a thickness of a side-view of an electronic book image, according to the size of the electronic file. If the thickness of the electronic file image is less than a preset size, when the display region reduction command is received, the controller 170 may support displaying the electronic file image as illustrated in screen 503.

Accordingly, as illustrated in screen 503 and screen 504, the invention allows a user to optionally reduce display regions of electronic images, such that a space in which more book images can be provided may be generated.

The controller 170 supports extending display regions of electronic book images according to a display region extension command. In FIG. 5, the display region extension command is displayed with a dotted line. For example, if one electronic book image is selected from electronic book images displayed with an overlapping view, as illustrated in screen 503, and input is received in a direction having an empty space in a corresponding exhibition region, the controller 170 determines the input as the display region extension command and adjusts an overlapping ratio. The controller 170 may reduce the overlapping ratio to a preset ratio. The preset ratio may be a certain ratio or a flexible ratio computed according to the empty space. When the fixed ratio is used, the controller 170 may re-control the overlapping ratio to 20% to output screen 502. Although not shown in FIG. 5, when the overlapping ratio is set to be adjusted to the flexible ratio, the controller 170 may compute and use a ratio that fills the empty space. As illustrated in screen 502, when a display region extension command is received in a display region of an overlapping view, namely a type of binding view, the controller 170 supports releasing a binding group and independently displaying respective electronic book images, as illustrated in screen 501. The controller 170 supports changing the electronic book files from the binding view to the individual view.

If an electronic book file is selected from the electronic book images displayed as illustrated in screen 504, and input is received in a direction toward an empty space of an exhibition region, the controller 170 determines the input as the display region extension command, as illustrated in screen 503, and converts a binding view of the electronic book images from the overlapping view to the side-by-side view. In addition, the controller 170 supports changing the electronic book images from a side-by-side view, as illustrated in screen 504, to an independently individual view, as illustrated in screen 501.

Accordingly, in the embodiment of the present invention illustrated in FIG. 5, when a display region extension command is received from a type of binding view, an empty space in an exhibition region is used as an additional display region. Accordingly, embodiments of the present invention enable information with more electronic book images to be provided to a user.

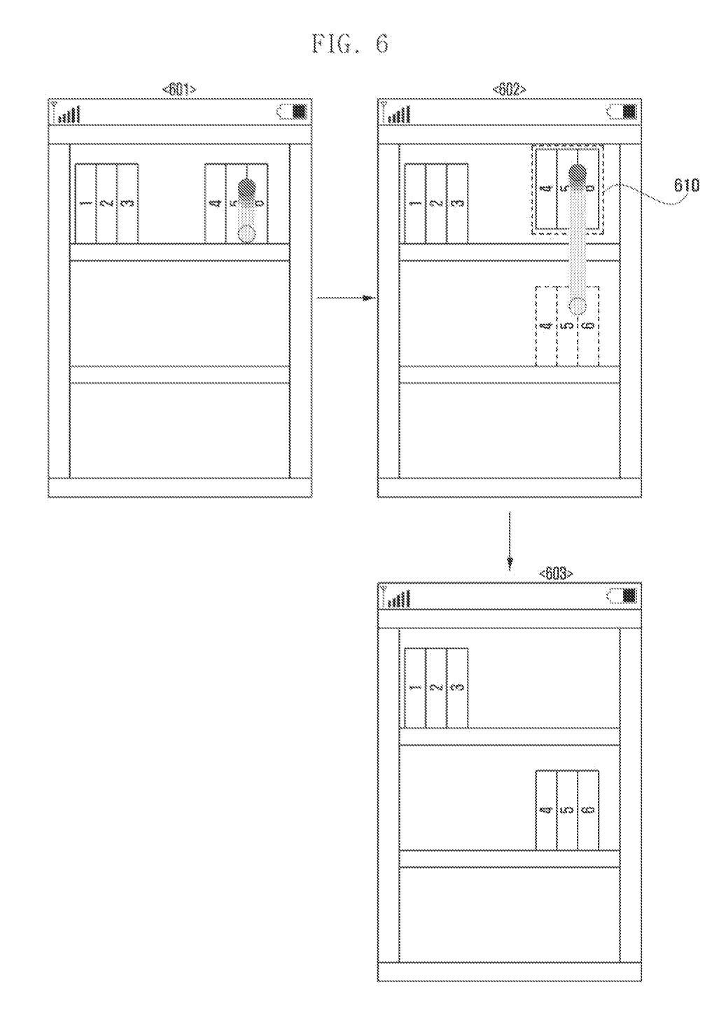

FIG. 6 is a diagram illustrating an example of a screen changing locations of electronic book images, according to an embodiment of the present invention.

FIG. 6 illustrates screens in which locations of a plurality of electronic book images, displayed as one binding group, are simultaneously changed.

In order to change locations of the electronic book images, if input is received in a preset vertical direction in a region of one of the binding groups, the controller 170 determines that the input selects the binding group, namely, a plurality of electronic book images included in the binding group, and controls the display unit 143 to display the binding group with a group selection view 610. The group selection view 610 indicates that one binding group is selected for changing a predetermined display. For example, it is determined that one binding group is selected, an animation in which the binding group is highlighted or extracted from an exhibition region may be realized. An operation for moving a binding group upward by a predetermined distance is illustrated as a selection view. If it is determined that location moving input to a certain destination is generated in a display region of a group selection view 610, the controller 170 supports changing a display location of a binding group according to the location moving input. The location moving input designates a termination of a binding group. Accordingly, the controller 170 may control the display unit 143 to display a binding group in a release location of the location moving input. The selection input of the binding group may be set to input in a horizontal direction.

If downward input is received in a binding group display region configured by an electronic book image 4 to an electronic book image 6, as illustrated in screen 601, the controller 170 determines that selection input of the binding group is received. Further, the controller 170 controls the display unit 143 to display the electronic book image 4 to the electronic book image 6 with the group selection view 610. If the location moving input is received in a display region of the group selection view 610, the controller 170 supports displaying the electronic book image 4 to the electronic book image 6 in a designated location of the location moving input.

Accordingly, an embodiment of the invention illustrated in FIG. 6 displays electronic book images according to a location moving input, which allows a user to easily arrange and manage the electronic files.

FIG. 6 illustrates that one binding group, namely, locations of electronic book images are changed. However, a location one electronic book image may be changed. For example, if preset selection input is received for location movement in one electronic book image region, the controller 170 may control the display unit 143 to display the one electronic book image with a selection view. Further, if the location moving input is received in a selection view of one electronic book image, the controller 170 may support such that the one electronic book image is displayed at a location designated by the location moving input.

Referring to FIG. 6, the foregoing embodiment of the present invention illustrates that when locations of a plurality of electronic book images are changed, they should be first displayed with the group selection view 610. However, when display of the group selection view 610 is omitted, and the location moving input is received after selection input with respect to a certain binding group, the controller 170 may support that a display location of the binding group is changed.

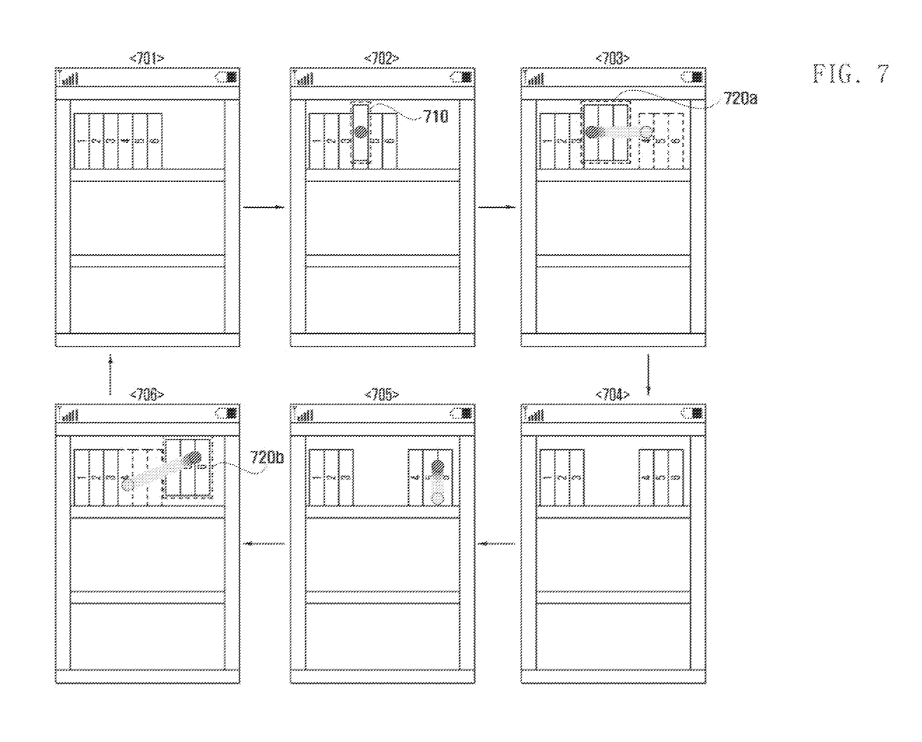

FIG. 7 is a diagram illustrating an example of a screen changing locations of electronic book images, according to another embodiment of the present invention.

Referring to FIG. 7, screens in which a location of a part or all of binding groups is changed to divide the binding groups and recombine the part of the binding groups with another binding group are illustrated.

To change locations of the electronic book images, if independent selection input with respect to one electronic book image of the binding groups is received, the controller 170 supports displaying the one electronic book image with a single selection view 710. The single selection view 710 indicates that the one electronic book image is selected to change the predetermined display. The single selection view 710 may be output in the same display scheme as in the group selection view 610 of FIG. 6. If preset input is received from a display region of the single selection view 710, the controller 170 determines that selection input of partial groups is received. Accordingly, the controller 170 determines that electronic book images displayed on a preset side are selected based on an independently selected electronic book image from the section input of partial groups and an independently selected in a corresponding binding group. The preset direction may be adjusted according to user tastes, or may be determined in a predetermined direction, according to an intention of a designer.

Accordingly, the controller 170 determines that a plurality of electronic book images are selected according to the group selection of partial groups, and supports displaying the selectively determined partial groups with group selection views 720a and 720b. Further, it is determined that location moving input to a certain destination is generated in a display region of the group selection views 720a and 720b. The controller 170 supports changing the display region of the selected partial group according to the location moving input.

For example, the controller 170 controls the display unit 143 to display one binding group configured by the electronic book image 1 to the electronic book image 6, as illustrated in screen 701. When independent input with respect to a certain electronic book image, for example, the electronic book image 4, in a binding group is received, the controller 170 displays the electronic book image 4 with the independent selection view 710 to express selection of the electronic book image 4, as illustrated in screen 702. When selection input of partial groups is received in a display region of the single selection view 710, the controller 170 determines that the electronic book image 4, the electronic book image 5, and the electronic book image 6, located to the right of the electronic book image 4 are selected, as illustrated in screen 703, and supports displaying the electronic book images 4-6 with a group selection view 720a. Specifically, the controller 170 supports displaying the electronic book image 4 to the electronic book image 6 to be extracted from a bookshelf, as illustrated in screen 703. Further, the controller 170 controls the display unit 143 to arrange the electronic book image 4 to the electronic book image 6 in a designated location, according to location moving input in a display region of the group selection view 720a, as illustrated in screen 704. As previously described, the electronic book images may be classified and arranged into a plurality of groups.

The controller 170 may support combining a plurality of binding groups with each other as one group. In more detail, when it is determined that location moving input is received after input of selection with respect to a certain binding group, the controller 170 may supports displaying a group selected according to a destination designated by the location moving input, to be combined with another group. For example, as illustrated in screen 705, the binding group 720b configured by the electronic book image 4 to the electronic book image 6 and location-moving input with respect to a selected binding group, as illustrated in screen 706, may be received. It is determined that a destination designated by location moving input in screen 706 is adjacent to another group, for example, a group of the electronic book image 1 to the electronic book image 3, the controller 170 may support such that the electronic book image 1 to the electronic book image 6 are displayed as one binding group.

Accordingly, as illustrated in FIG. 7, the controller 170 supports managing electronic book images by groups according to the series of selection input and display change input.

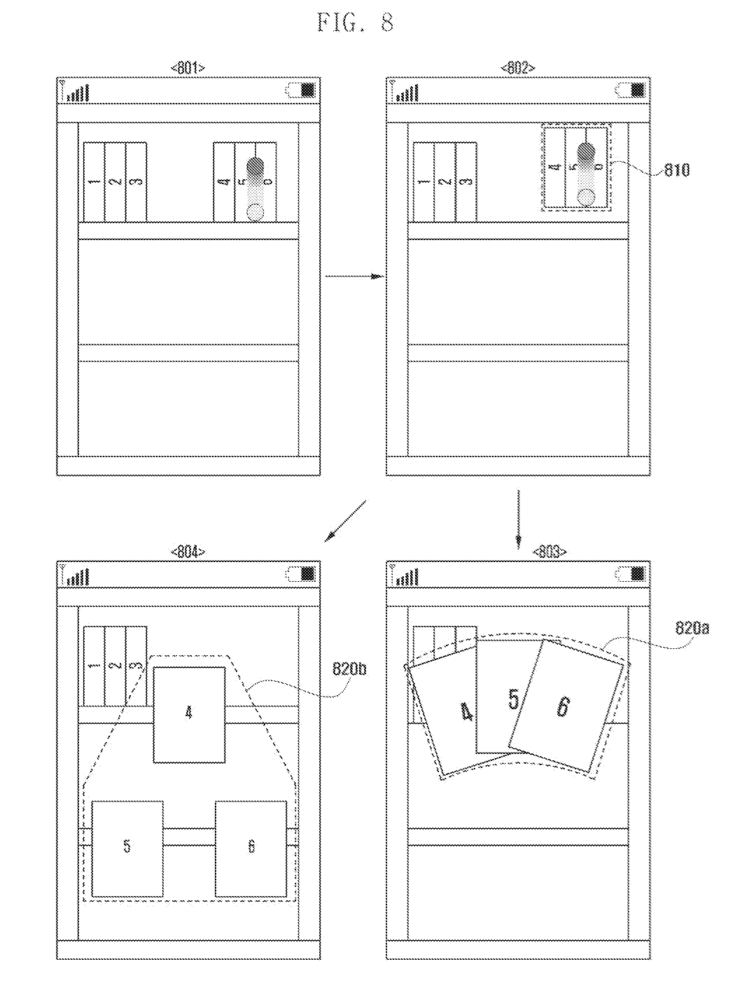

FIG. 8 is a diagram illustrating a screen for providing a preview of a plurality of electronic book images, according to an embodiment of the present invention.

Referring to FIG. 8, a screen in which a certain binding group is selected and previews of a plurality of electronic book images constructing the selected group is illustrated.

For a preview display of a plurality of electronic book images, if selection input for a certain binding group is received, the controller 170 controls the display unit 143 to display the binding group with a group selection view 810. Further, if preview display input is received in a display region of the group selection view 810, the controller 170 supports displaying preview images 820a and 820b corresponding to a plurality of electronic book images configured as a selected binding group. The preview display input is preset input and may be generated in a group or single selection view display region. Further, the preview display input may set a group or single selection input as the same type of input. The preview images 820a and 820b may be an image in which a front view of an electronic book image is extended, or an image displaying brief information, for example, a title page or a list with respect to an electronic file. In addition, the preview image may overlay an electronic file management screen.

If it is determined that a binding group configured by the electronic book image 4 to the electronic book image 6 is selected, as illustrated in screen 801, the controller 170 supports such that the binding group is displayed with the selection view 810, as illustrated in screen 802. Further, preview display input, for example, input in a certain vertical direction is received in a display region of the group selection view 810, as illustrated in screen 802, the controller 170 may remove the electronic book image 4 to the electronic book image 6, and instead support displaying a preview image 820a corresponding to the electronic book image 4 to the electronic book image 6 overlaying an electronic file management screen, as illustrated in screen 803. The controller 170 may control the display unit 143 to display the plurality of preview images 820a overlapping each other, or with a certain layout, as illustrated in screen 804. The controller 170 may adjust the size of a preview image such that it may be displayed to an optimized size in one screen according to the number of preview images. If selection input with respect to one of the displayed preview images 820a and 820b is received, the controller 170 may support providing a reading view image. The reading view image may be configured by a combination of texts and images to show contents of an electronic file. Furthermore, the controller 170 may remove preview images and again display the electronic book image 4 to the electronic book image 6, according to preset preview termination input.

Referring to FIG. 8, the foregoing embodiment of the present invention illustrates that the selection view 810 should be first displayed so as to display a preview image of a plurality of electronic book images. When display of the selection view 810 is omitted, and preview display input is received after selection input with respect a certain binding group, the controller 170 may support displaying a preview image corresponding to a plurality of selected electronic book images.

Embodiments of the present invention may provide only one preview image.

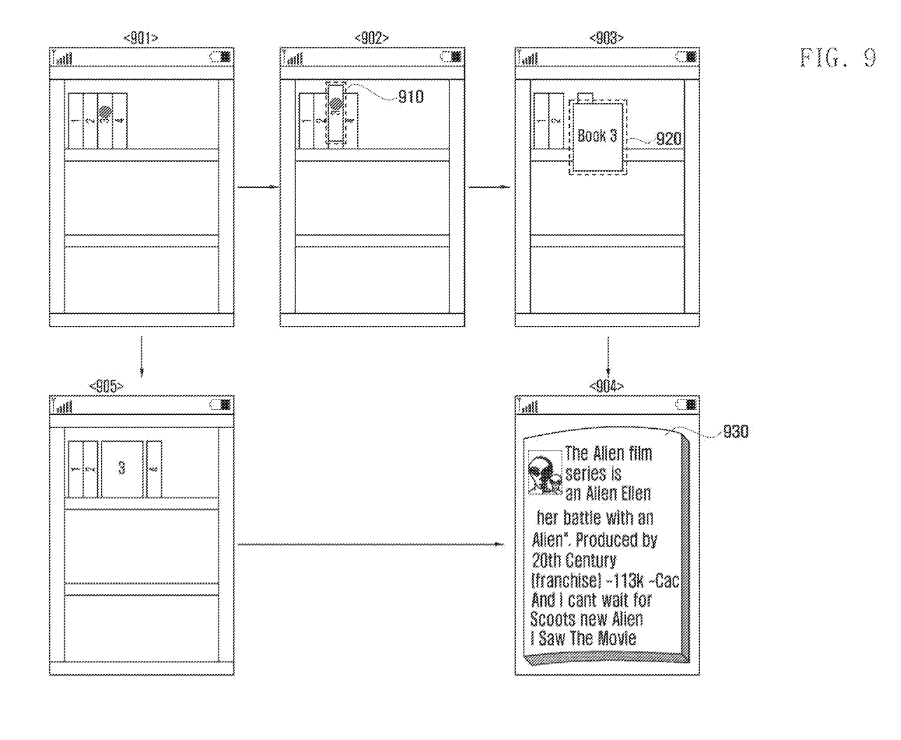

FIG. 9 is a diagram illustrating a screen for providing a preview image and a reading view image for one electronic file, according to an embodiment of the present invention.

Referring to FIG. 9, a certain electronic book image is selected and a screen on which a preview image 920, corresponding to the selected electronic book image, and a screen on which a reading view image 930 is displayed, are illustrated.

So as to display one preview image, if single selection input for a certain electronic book image is received, the controller 170 supports displaying the selected electronic book image with a single selection view 910. Moreover, if preview display input is received in a view display region of the single selection 910, the controller 170 supports a preview image corresponding to a selected electronic book image. The one selected electronic book image may be one of a binding group, or may not be included in any group.

As illustrated in screen 901, if single selection input for one electronic book image, for example, the electronic book image 3 of a binding group is received, the controller 170 supports displaying the electronic book image 3 with the single selection view 910.

Furthermore, as illustrated in screen 902, if preview display input is received in a display region of the single selection view 910, the controller 170 may control the display unit 143 to remove the electronic book image 3 and overlay the preview image 920 corresponding to the electronic book image 3, as illustrated in screen 903.

Moreover, the controller 170 may support displaying a corresponding reading view image 930 according to reading view display input received from a display region of the preview image 920. For example, when reading view display input, and tap input is received from a region of the preview image 920 of screen 903, the controller 170 may control the display unit 143 to display a corresponding electronic file with the reading view image 930, as illustrated in screen 904. Further, as illustrated in screen 905, when an electronic book image displayed with a front view is selected, the controller 170 may support displaying the reading view image 930. Accordingly, embodiments of the present invention provides contents of a displayed electronic file through the reading view image 930.

In addition, the controller 170 may support selecting an individual view of an electronic book image according to an individual view conversion input. For example, when a single selection is input in a state that the′ electronic book image 3 is displayed with a side view, as illustrated in screen 901, the controller 170 may support displaying the electronic book image 3 with a front view, as illustrated in screen 905. By contrast, single selection input with respect to the electronic book image 3, displayed with a front view, is received, the controller 170 may support displaying a side view of the electronic book 3. Embodiments of the present invention allow a user to simply confirm electronic book information.

FIGS. 6-9 illustrate that the display of electronic book images is controlled according to selection input and display change input occurring when a binding group is displayed with the side-by-side view. When the binding group is displayed with an overlapping view, the display of electronic images may be controlled in the same manner.

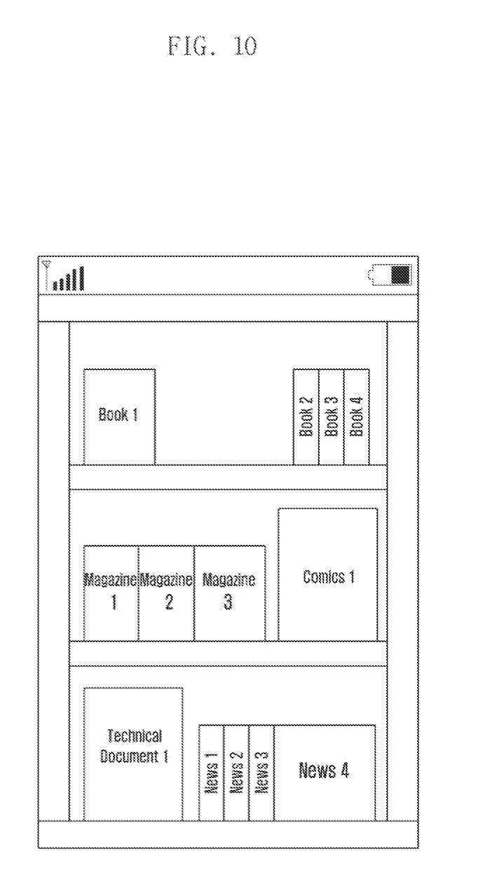

FIG. 10 is a diagram illustrating a screen for actively displaying electronic book images, according to an embodiment of the present invention.

As shown in FIG. 10, the invention may group the electronic books and change locations thereof, according to user input, such that the electronic books are classified and arranged to be easily managed.

Accordingly, as described above, the invention provides a method of interactively displaying electronic file images, such that the display of the electronic file images can be operated according to user input. Embodiments of the present invention allow a user to freely use a limited exhibition region to display and arrange file images. In addition, embodiments of the present invention provide an approach that allows a user to optionally display electronic files by groups to easily recognize relationships between the electronic files. Accordingly, embodiments of the present invention provide a method and apparatus for interactively displaying electronic files to conveniently manage the electronic files.

The foregoing embodiment of the present invention illustrates that there is an electronic document file as a representative example of an electronic file. The invention may embody various types of electronic files. For example, the electronic file may include an audio file, a video file, and an image file. Accordingly, the invention may use a CD case, a DVD case, and a thumbnail, as an electronic file image corresponding to the audio file, the video file, and the image file, respectively. A type of the electronic file image is not limited thereto.

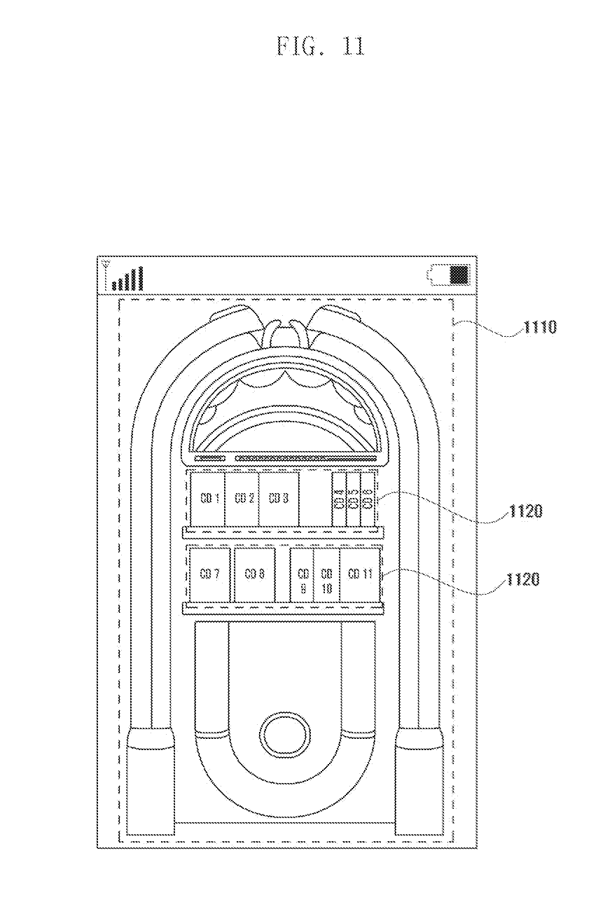

An embodiment of the present invention implemented when the electronic file is the audio file is described with reference to FIG. 11.

FIG. 11 is a diagram illustrating a screen for actively displaying CD case images, according to an embodiment of the present invention.

Referring to FIG. 11, an electronic file management screen is displayed with a jukebox, and an exhibition region in the jukebox is divided into shelves. A plurality of CD case images may be displayed in each of the exhibition regions. A certain album jacket may be displayed with a front view of the CD case image, and identification information of an audio file such as an album title and a singer name may be displayed. Further, an album list may be displayed with a preview image, and an audio file playback screen may be displayed with a reading view image.

As described above, if selection input of a certain type and display change input are received, the controller 170 controls display of CD case images, according to an embodiment of the present invention. As described above, the embodiments of the present invention is applicable to display management of various types of electronic files.

Embodiments of the present invention are implemented with a 2-Dimensional (2D) image in FIGS. 4-11, and a description associated therewith. However, persons of ordinary skill in the art will appreciate that the invention may be embodied using a 3-Dimensional (3D) effect.

A method and an apparatus for interactively displaying electronic file images, according to an embodiment of the invention, may support operating the display of the electronic file images to implement more convenient management of electronic files.

While the invention has been shown and described with reference to certain embodiments thereof, it will be understood by those of ordinary skill in the art that various changes in form and detail may be made therein without departing from the spirit and scope of the invention, as defined by the appended claims.

What is claimed is:

1. A method of displaying electronic files, the method comprising the steps of:
displaying electronic file images in at least one divided exhibition region;
determining whether a plurality of electronic file images is selected from the electronic file images based on a selection input;
receiving a display change input for changing a display of the plurality of electronic file images when the plurality of electronic file images is selected from the electronic file images; and
changing a display of the plurality of electronic file images according to the display change input.

2. The method of claim 1, wherein the plurality of electronic file images are displayed as a first view or a second view, and the first view has a wider display region than that of the second view.

3. The method of claim 2, wherein the display change input forms the display of the plurality of electronic file images as one group, and
wherein the display of the plurality of electronic file images is changed to adjacent locations in the at least one divided exhibition region.

4. The method of claim 3, wherein the display of the plurality of electronic file images is changed to the first view, one of the plurality of electronic file images is entirely displayed, and remaining electronic file images of the plurality of electronic file images are partially displayed according to a preset ratio.

5. The method of claim 4, wherein the preset ratio is adjustable.

6. The method of claim 3, wherein the display of the plurality of electronic file images is changed to the second view.

7. The method of claim 2, wherein the display change input adjusts display regions of the plurality of electronic file images, and
wherein the display of the plurality of electronic file images is changed to adjacent locations in the at least one divided exhibition region, or display regions of the plurality of electronic file images are reduced or increased.

8. The method of claim 7, wherein the display regions of the plurality of electronic file images are reduced when a display region of one of the plurality of electronic file images is reduced according to a preset ratio, or the plurality of electronic file images are converted from display in the first view to display in the second view.

9. The method of claim 7, wherein the display regions of the plurality of electronic file images are increased when a display region of one of the plurality of electronic file images is increased according to a preset ratio, or intervals of the plurality of electronic file images are increased

10. The method of claim 1, wherein the display change input indicates the selection of the plurality of electronic file images, and
wherein the plurality of electronic file images are selected.

11. The method of claim 1, wherein the display change input is for displaying a preview of the plurality of electronic file images, and
wherein a preview image of the plurality of electronic file images is displayed.

12. The method of claim 1, wherein the display change input is for moving locations of the plurality of electronic file images, and the plurality of electronic file images are displayed at a location designated by the display change input.

13. The method of claim 1, wherein the plurality of electronic file images are selected, and another display change input is received.

14. The method of claim 13, wherein the other display change input is for moving locations of the plurality of electronic file images to be selected and displayed, or for displaying a preview.

15. An apparatus for displaying electronic files, the apparatus comprising:
a touch screen including a display unit for outputting electronic file images in at least one divided exhibition region, and a touch panel for receiving user input with respect to the electronic file images; and
a controller receiving a selection input of a plurality of electronic file image and a display change input from the touch screen, and controlling the touch screen to change a display of the plurality of electronic file images selected according to the display change input when it is determined that the plurality of electronic file images are selected according to the selection input.

16. The apparatus of claim 15, wherein the display change input is for forming and displaying the plurality of electronic file images as one group, and
wherein the controller controls the touch screen to display the plurality of electronic file images in adjacent locations in the at least one divided exhibition region.

17. The apparatus of claim 16, wherein the controller controls the touch screen to display the plurality of electronic file images to overlap at a preset rate in a predetermined direction, and wherein the preset rate is adjustable.

18. The apparatus of claim 16, wherein the controller controls the touch screen to display the plurality of electronic file images to be stored in the at least one divided exhibition region.

19. The apparatus of claim 15, wherein the display change input is for adjusting a display region of the plurality of electronic file images, and
the controller controls the touch screen to display the plurality of electronic file images to overlap with a preset rate in a predetermined direction, to display the plurality of electronic file images to be stored in the at least one exhibition region, or to individually display the plurality of electronic file images.

20. The apparatus of claim 15, wherein the controller controls the touch screen to display that the plurality of electronic file images are selected when the display change input is for indicating the selection of the plurality of electronic file images, the controller controls the touch screen to display the plurality of electronic file images in a location designated by the display change input when the display change input is for moving locations of the plurality of electronic file images, and the controller controls the touch screen to display the plurality of electronic file images when the display change input is for displaying a preview of the plurality of electronic file images.
